(19) United States
(12) Patent Application Publication
(10) Pub. No.: US 2017/0312715 A1
(43) Pub. Date: Nov. 2, 2017

(54) CARTRIDGE FOR MIXING DME FUEL WITH ADDITIVES

(71) Applicant: VOLVO TRUCK CORPORATION, Göteborg (SE)

(72) Inventors: Karl TASIK, Hagerstown, MD (US); Allison ATHEY, Frederick, MD (US)

(21) Appl. No.: 15/525,728

(22) PCT Filed: Nov. 14, 2014
(86) PCT No.: PCT/US14/65679

§ 371 Date: May 10, 2017

(51) Int. Cl. B01F 15/02; F02M 21/02; B67D 7/74; B01F 15/04; C10L 1/02; B01F 3/08; B60K 15/04; F02M 25/00; B67D 7/04; B60K 15/03

(52) U.S. Cl. CPC B01F 15/0232; F02M 25/00; F02M 21/0221; F02M 21/0212; B67D 7/741; B01F 15/026; B01F 15/0416; C10L 1/02; B01F 3/0865; B60K 15/04; B60K 2015/03348; B67D 7/04; C10L 2290/24

(57) ABSTRACT

A fuel additive cartridge for use with a dimethyl-ether fuel system of a vehicle includes a reservoir for storing and dispensing a liquid fuel additive into a flow of fuel in a fill conduit during refueling. The cartridge also includes a dispenser actuated by the fuel flow to selectively dispense the liquid fuel additive from the reservoir. The fuel additive cartridge is intended to attach to a dimethyl-ether fuel system at a location between a fueling inlet connector and a storage tank to facilitate a metered mixing of liquid fuel additive from the cartridge and dimethyl-ether during the re-fueling of the storage tank.

### TECHNICAL FIELD

This disclosure relates to a device and method for providing fuel additives to a fuel system. Particularly, this disclosure relates to the use of removable cartridges to mix fuel additives into a vehicle's dimethyl-ether fuel system.

### BACKGROUND AND SUMMARY

Use of alternative fuels for vehicles to replace gasoline and diesel is increasing in the market place. Alternative fuels include compressed natural gas (CNG), liquefied natural gas (LNG), and dimethyl-ether (DME). DME is a manufactured, rather than naturally occurring, alternative fuel. It is a colorless, odorless, and tasteless compound that can be produced from natural gas, or from CO₂-neutral biomass. It is believed to be non-toxic and non-carcinogenic. DME's molecular formula is CH₃OCH₃, and it behaves similarly to propane. Since the structure of DME lacks carbon-carbon bonds, it does not produce particulates in the combustion process. It can be stored at ambient temperatures and can be stored and transported in tanks under pressures similar to those used in the propane industry. DME is also able to provide stored-energy content similar to Liquefied Natural Gas without the need for cryogenic storage.

As new DME fuel systems develop for powering vehicles, so too do the challenges faced by the DME fuel system designers. One such challenge involves the low lubricity of DME and the potential for premature wear on fuel system components, including seals, fuel pumps and injectors. DME has been found to create corrosion issues when used with materials and components converted from diesel-type fuel systems. Another concern in the use of DME involves leak detection; pure DME is colorless, odorless and tasteless.

Therefore there is a need for an apparatus and method of using the apparatus to address the foregoing concerns.

The present disclosure describes a device for supplementing fuel-grade dimethyl-ether with additives to increase the usability of DME as a vehicle fuel. Conventional diesel fuel is provided with additives by fuel suppliers as there is a strong infrastructure in place. DME is a new fuel, however, and the infrastructure is lacking. The disclosed method and apparatus would ensure the fuel for the customers meets the necessary specification for operation.

The present disclosure describes a fuel additive cartridge attachable to a DME fuel system of a vehicle to ensure sufficient mixing of fuel grade DME and additives that limit fuel system degradation.

The present disclosure describes a DME fuel system for a vehicle that includes a fuel additive cartridge removably attached to the fueling system upstream of the storage tank to provide a sufficient amount of additive into the DME fuel supply during refueling.

The present disclosure includes a method of mixing DME with fuel additives by using a fuel additive cartridge that releases additive material into a flow of DME during the re-fueling process.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

The features and advantages of the present invention are well understood by reading the following detailed description in conjunction with the drawings in which like numerals indicated similar elements and in which:

FIG. 1 represents an example vehicle utilizing the embodiments of the present disclosure;

FIG. 2 is a schematic representation of a DME fuel system according to some embodiments of the present disclosure;

FIG. 3 is a cartridge according to a first embodiment of the present disclosure;

FIG. 4 is a cartridge according to a second embodiment of the present disclosure.

FIG. 5 is a cartridge according to a third embodiment of the present disclosure.

### DETAILED DESCRIPTION

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

The present disclosure provides an apparatus for combining a fuel additive package with oncoming dimethyl-ether (DME), a DME fuel system, and a method of providing additives to dimethyl-ether (DME) fuel systems.

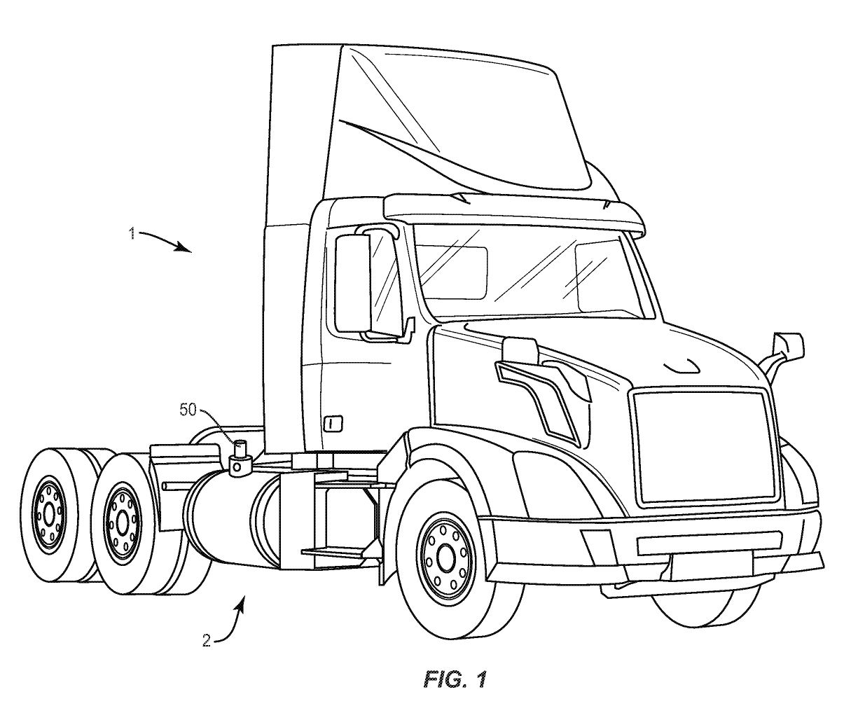

FIG. 1 shows the cab of a tractor truck 1. The tractor truck 1 may be equipped with a DME fuel system 2 that incorporates the disclosed apparatus for providing additives. Particularly, commercial and heavy-duty vehicles may be early adopters of alternative fuels such as DME because the long hours of operation and long distances traveled under heavy loads and under harsh towing conditions generally result in high levels of fuel consumption. Commercial vehicles may also be initial beneficiaries of DME fuel technology because their established routes from pick-up to drop-off may better align with potential regional re-fueling and infrastructure requirements that allow vehicles to come back to the same location to be fueled. That being said, this disclosure is not limited to commercial or industrial vehicle applications such as that shown in FIG. 1.

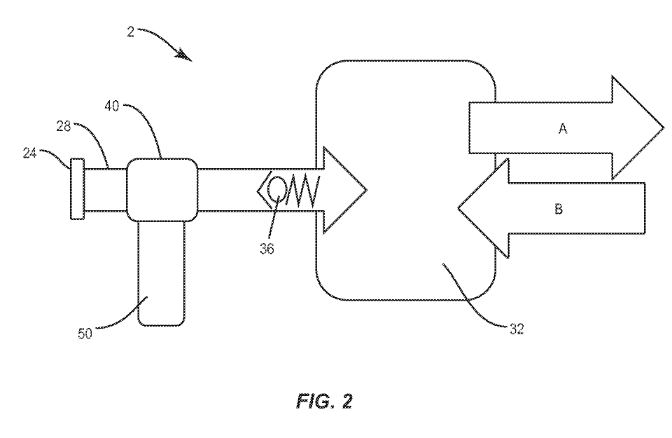

FIG. 2 schematically shows a DME fuel system 2 according to embodiments of the present disclosure. The DME fuel system 2 includes an inlet connector 24. The inlet connector 24 provides a sealable joint for coupling the DME fuel system 2 to an external source of DME (not shown), such as a conduit from a supply reservoir (not shown). The inlet connector 24 may be similar to re-filling connectors used in the propane industry because of similar pressures. However, it should be recognized that propane-type connectors should be designed with DME specific materials to avoid premature degradation of sealing portions. The inlet connector 24 may be positioned in nearly any location based upon the packaging requirements of the larger environment, i.e. the truck. For example, the inlet connector may be integrated with a storage tank 32, positioned adjacent to the storage tank 32, or located remotely from the storage tank 32 so long as fluid communication can be selectively maintained between the inlet connector 24 and the storage tank 32.

A neck 28 may extend from the inlet connector 24 to the storage tank 32. The neck 28 is a supply conduit between the inlet connector 24 and the storage tank 32. The storage tank 32 is configured to house DME under sufficient pressure to maintain the majority of the DME therein in a liquid state. Pressure of approximately 5 bar at 20 degrees C. is generally sufficient, which is significantly less than the 240-300 bar holding pressures used with existing compressed natural gas fuel systems. Lower storage pressure has several advantages, including reducing the weight of the storage tank 32 because it does not need to be as strong as an LNG tank. The storage tank 32 should not be completely full of liquefied DME, but should allow headspace for DME held in equilibrium with some portion of the DME in a gaseous state.

As should be understood, additional fuel lines (represented by an arrow A in FIG. 2) should lead to the vehicle's engine to be combusted within the engine to power the vehicle. Other fuel lines (represented by an arrow B in FIG. 2) can be provided from the engine to return unburned fuel to the storage tank 32.

A check valve 36 can be disposed within the neck 28. The stopper valve 36 is a one-way valve that allows pressurized DME to be pumped into the storage tank 32 during the re-fueling process, but prevents DME from the storage tank 32 from being discharged back through the neck 28.

A cartridge 50 containing a fuel additive is connected in fluid communication with the neck 28. The cartridge 50 configured to provide a metered flow of suitable liquid fuel additive into a stream of DME flowing through the neck 28 as the user is re-fueling the DME fuel system 2. The metered flow adds the liquid fuel additive in a controlled manner. The cartridge 50 may be replaceably mounted to the DME fuel system 2 using a joint 40 attached to or integrated with the neck 28. The joint 40 may provide a mechanical, sealed connection with the cartridge 50. The connection between the joint 40 and the cartridge 50 may be a compression attachment similar to how fuel filters are attached to diesel systems.

As mentioned above, fuel additives are desired for the DME fuel system 2 because use of substantially pure dimethyl-ether has low lubricity which may lead to accelerated wear of system components and may corrode standard fuel system components. Use of pure DME is believed likely to be damaging to even specially selected materials. Even if DME-resistant fuel system components could be identified, they may add significant expense relative to conventional fuel lines, tanks, seals and other components.

By incorporating fuel additives at the neck 28 between the inlet connector 24 and the stopper valve 36, a pressure drop as the relatively high pressure new fuel flows into the storage tank 32, having a lower pressure, can draw out the fuel additive from the cartridge 50. Further, the duration that the cartridge 50 is exposed to the pressure drop would be proportional to the amount of fuel additive being mixed into the oncoming DME. Because the fuel additive is included to protect the fuel system components, it is helpful to mix in the fuel additive prior to introduction into the storage tank 32, thereby protecting nearly all of the DME fuel system 2. Further, because the mixing location is upstream of the stopper valve 36, the fuel additive should be combined with the DME only during re-fueling.

Mixing the fuel additive with the DME at a location onboard the vehicle, rather than at a fueling station, may have additional benefits. For example, it is understood to be important that the DME remain properly mixed with the fuel additive and not separate prior to use by the engine. By performing the mixing onboard the vehicle, as compared to pre-mixed DME held within a fueling station, the likelihood that the DME would separate from the additives is reduced because their time between mixing and use is minimized.

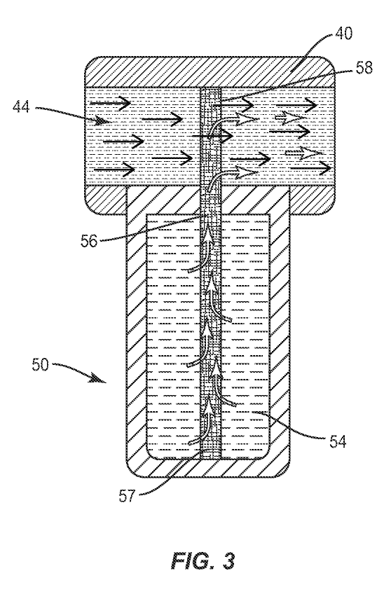

The cartridge 50 provides a reservoir 54 for a liquid fuel additive (see FIGS. 3-5). The liquid fuel additive may be a mixture or composition of one or more ingredients, including but not limited to: a lubricity agent, a cleaner, and an odorant. If multiple ingredients are used, they may be preferably combined into a single reservoir 54 in a single cartridge 50. However, each ingredient could be separately stored within a single cartridge 50 or stored in separate cartridges 50 attached to the same DME fuel system 2. The liquid fuel additive may be petroleum based.

The lubricity agent helps lubricate the flow of DME within the DME fuel system 2. Most compositions of the liquid fuel additive will include at least one lubricity agent. Increased lubrication assists with the prevention of corrosion and seizing of moving parts. Pure DME may not provide a suitable vehicle fuel without a lubricity agent. Examples of lubricity agents reported in the art are castor oil and Lubrizol LZ539N. The liquid fuel additive may also include a clearer to assist with removing deposits or buildup within the DME fuel system 2. The liquid fuel additive may also include an odorant, which may be required by government regulation. Adding a scent to the DME may help a user to identify the presence of a leak of DME from the DME fuel system 2. Odorants may be selected from known odorants commonly associated with gases, to prevent the need to train users about a new association between the odorant and the potential issue with the DME fuel system 2. An example odorant includes ethyl mercaptan, which is used for LPG fuels.

It is important that the liquid fuel additive composition has the proper ratio of ingredients and that the DME is mixed with a sufficient amount of the liquid fuel additive. For example, Hansen and Mikkelsen reported in “DME as a Transportation Fuel” (Danish Road Safety & Transport Agency, July 2001, available at

www.traficstyrelsen.dk/en/˜/media/738f64ff03a04edea7e8a86e4e0cb6db.pdf) the addition of 1000 ppm Lubrizol LB539N and 20 ppm ethyl mercaptan to DME fuel. Use of other lubricity agents, cleaners or odorants may require adjusting the quantities.

FIG. 3 shows a first embodiment of a cartridge 50. The cartridge 50 includes a reservoir 54 for storing the liquid fuel additive and a wicking media 56. The wicking media has a first end 57 within the reservoir 54 and a second end 58 extending to an exterior of the cartridge 50 and into a flow passage 44 that extends through the joint 40. The wicking media 56 is an example of one possible dispenser used for selectively allowing liquid fuel additive to travel from the reservoir 54 into the flow passage 44. In some embodiments the flow passage 44 may extend through the neck 28 with the joint 40 attached to only a portion of the neck 28. Liquid fuel additive is absorbed by the wicking media 56 and is channeled into the flow passage 44. As DME, most likely in a liquefied state, is forced through the flow passage 44, liquid fuel additive is pulled out of the wicking media 56 and incorporated with the DME flowing through the flow passage 44. The duration of the flow past the wicking media 56 can be approximately proportional to the amount of liquid fuel additive incorporated into the DME. The materials selected for the wicking media 56 and the area of the wicking media 56 that is exposed into the flow passage 44, would therefore be selected for the ability to transfer liquid fuel additive into the DME over the given DME re-fueling flow period. For example, the wicking media 56 may be fabrics made from synthetic materials such as nylon or foams made from compatible plastics such as polypropylene. The flow passage 44 should be sized to allow re-fueling at a rate comparable with current re-fueling rates for diesel fuel. The wicking media 56 surface area will be selected based on the ability of the wicking material to draw the selected additive composition into the fuel flow at the appropriate rate.

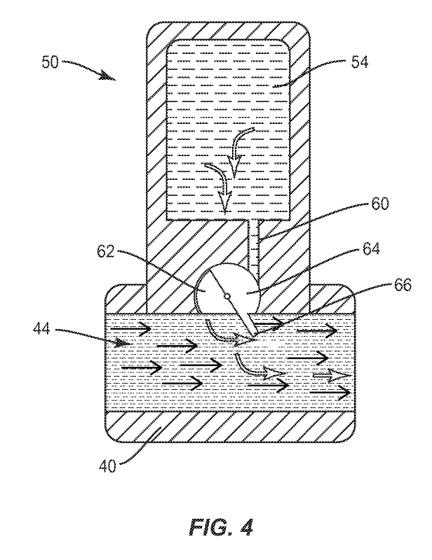

FIG. 4 shows a second embodiment of a cartridge 50 with a second type of dispenser. The cartridge 50 includes a reservoir 54 for storing the liquid fuel additive. The reservoir 54 is connected to a plenum 62 by way of an orifice 60. In the illustrated embodiment, the cartridge 50 would be substantially positioned above the flow passage 44 to allow gravity to feed a metered rate of liquid fuel additive from the reservoir 54 through the orifice 60 into the plenum 62. When there is no DME flow through passage 44, the plenum 62 is closed by a pivotable cover 64. The cover 64 has a lever arm 66 acted on by the DME flow and is biased to the closed position by a spring or similar device. Flow of DME through the flow passage 44 may act on the lever arm 66 to rotate the cover 64 and open the plenum 62 to the flow passage 44. Opening the cover 64 allows the additive in the plenum 62 to flow into the flow passage 44 to mix with the oncoming DME. When in the open position, the cover 64 may block the orifice 60 to prevent unwanted addition of liquid fuel additive. When the flow of DME stops, the cover 64 returns to the closed position. In the closed position of the cover 64, the plenum 62 can be re-filled with liquid fuel additive through the orifice 60. The plenum 62 should accommodate a volume of liquid fuel additive that would be sufficient for an entire tank-full of DME in case the storage tank 32 is nearly empty prior to re-fueling.

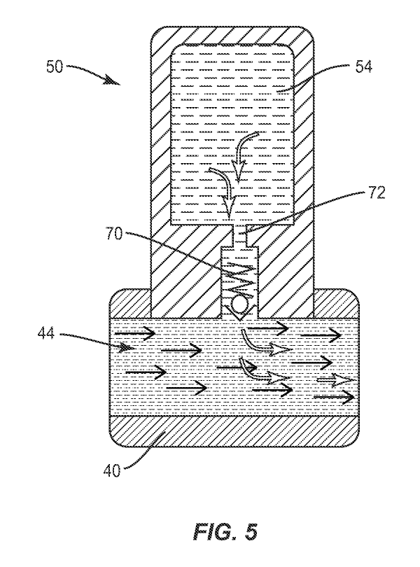

FIG. 5 shows a third embodiment of a cartridge 50 that includes a third type of dispenser, a pressure release valve 70 to selectively allow liquid fuel additive into the flow passage 44. The pressure provided by the oncoming flow of DME would force open the pressure release valve 70. Like the embodiment of FIG. 4, the cartridge 50 illustrated in FIG. 5 may be disposed above the flow passage 44 to allow gravity to force liquid fuel additive into the flow when the pressure release valve 70 is open. The cartridge 50 includes an aperture 72 which should be of such size to provide a desired flow rate of liquid fuel additive into the DME when the pressure release valve 70 is open. Alternatively, a re-fillable plenum may be incorporated into the illustrated embodiment to provide dosed addition of liquid fuel additive. Like the cover 64 of FIG. 4, the pressure release valve 70 may be configured to block flow from the reservoir 54 into an optional plenum when in the open position, and allow flow from the reservoir 54 to the plenum in the closed position.

Several embodiments of cartridges 50 have been described above. Other cartridge embodiments will be apparent to those having skill in the art. Particularly, the cartridges 50 provide for mechanism release of the liquid fuel additive without the use of complex sensors and electronics.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents. Features from one embodiment or aspect may be combined with features from any other embodiment or aspect in any appropriate combination. For example, any individual or collective features of method aspects or embodiments may be applied to apparatus, product or component aspects or embodiments and vice versa.

1. A fuel additive cartridge for a vehicle fuel system, comprising:
a reservoir for a liquid fuel additive, suitable for use with dimethyl-ether, configured to be attached to a fuel fill conduit; and
a dispenser configured to selectively dispense the liquid fuel additive from the reservoir during fueling when fuel is flowing in the fill conduit.

2. The cartridge of claim 1, wherein the dispenser comprises a wicking media, the wicking media has a first end within the reservoir for contact with the liquid fuel additive, and a second end extending exterior of the cartridge for positioning in the fill conduit to dispense the additive.

3. The cartridge of claim 1, wherein the dispenser comprises a cover that is acted on by flowing fuel in the fill conduit to selectively open to allow a fixed amount of liquid fuel additive to exit the cartridge.

4. The cartridge of claim 3, wherein the cover is biased to a closed position.

5. The cartridge of claim 3, wherein the cover includes a lever arm acted on by the flowing fuel for rotating the cover from a closed position to an open position.

6. The cartridge of claim 3, further comprising an orifice leading from the reservoir into a plenum, wherein the cover closes the plenum and wherein the volume of the plenum is configured to dose the liquid fuel additive.

7. The cartridge of claim 6, wherein the reservoir is in fluid communication with the plenum, via the orifice, when the cover is closed and the reservoir is not in fluid communication with the plenum when the cover is open.

8. The cartridge of claim 1, wherein the dispenser comprises a pressure release valve controlling flow from the reservoir that opens using filling pressure during re-fueling to allow metered flow of the liquid fuel additive from the reservoir out of the cartridge.

9. A dimethyl-ether fuel system for a vehicle, comprising:
an inlet connector for attachment to an external fuel source during re-fueling;
a neck leading from the inlet connector to a storage tank;
a joint positioned along the neck; and
a cartridge, the cartridge comprising a reservoir for storing a liquid fuel additive suitable for use with dimethyl-ether, the cartridge being removably attached to the joint, wherein when attached to the joint, the cartridge is configured to provide selective fluid communication between the reservoir and the neck by action of dimethyl-ether passing through the neck during re-fueling, such that fuel additive is added in a controlled manner to the dimethyl-ether flowing from the inlet connector to the storage tank during re-fueling.

10. A fuel system of claim 9 wherein the cartridge comprises a dispenser configured to selectively dispense the liquid fuel additive from the reservoir.

11. The fuel system of claim 10, wherein the dispenser comprises a wicking media, the wicking media has a first end disposed within the reservoir that absorbs the liquid fuel additive, and a second end extending into a flow passage of the neck.

12. The fuel system of claim 10, wherein the dispenser comprises a plenum in fluid communication with the reservoir and a cover that selectively opens to allow an amount of liquid fuel additive contained in the plenum to exit the plenum.

13. The fuel system of claim 12, wherein the cover is spring-biased to a closed position.

14. The fuel system of claim 12, wherein the cover include a lever arm for rotating the cover between an open position and a closed position.

15. The fuel system of claim 12, further comprising an orifice leading from the reservoir to the plenum, wherein the volume of the plenum is configured to dose the liquid fuel additive.

16. The fuel system of claim 10, wherein the dispenser comprises a pressure release valve that opens when pressure is applied to allow flow of the liquid fuel additive from the reservoir out of the cartridge.
